(19) United States
(12) Patent Application Publication
(10) Pub. No.: US 2013/0328749 A1
(43) Pub. Date: Dec. 12, 2013

(54) VOLTAGE THRESHOLD DETERMINATION FOR A PIXEL TRANSISTOR

(71) Applicants: Shafiq M. Jamal, Pleasanton, CA (US); Yafei Bi, Palo Alto, CA (US); Hopil Bae, Sunnyvale, CA (US); Sang Y. Youn, Cupertino, CA (US)

(72) Inventors: Shafiq M. Jamal, Pleasanton, CA (US); Yafei Bi, Palo Alto, CA (US); Hopil Bae, Sunnyvale, CA (US); Sang Y. Youn, Cupertino, CA (US)

(73) Assignee: APPLE INC, Cupertino, CA (US)

(21) Appl. No.: 13/592,176

(22) Filed: Aug. 22, 2012

Related U.S. Application Data
(60) Provisional application No. 61/657,359, filed on Jun. 8, 2012.

(51) Int. Cl. G09G 3/20

(52) U.S. Cl. 345/55

(57) ABSTRACT

A display is disclosed that includes a transparent substrate and a plurality of pixel transistors that are formed on the transparent substrate to generate an image for display. A transistor drive circuit is used to drive the pixel transistors to generate the image. The transistor drive circuit may include a gate driver. Further, a test circuit may be used to: adjust voltages that are applied by the gate driver to a pixel transistor; and determine the voltage of the gate driver when a current spike has occurred to the pixel transistor which causes the pixel transistor to turn on. Once this threshold voltage for the gate driver to turn on the pixel transistor has been determined, it may be stored in a storage device for future use by the gate driver. Other embodiments are also described and claimed.

### CROSS-REFERENCE TO RELATED APPLICATION

This application is based upon and claims the benefit of priority from U.S. Provisional Patent Application No. 61/657,359, filed on Jun. 8, 2012; the entire contents of which are incorporated herein by reference.

### FIELD

An embodiment of the invention generally relates to electronic display devices and, more particularly, to active matrix thin film transistor (TFT) flat panel displays. Other embodiments are also described.

### BACKGROUND

Flat panel displays such as liquid crystal display (LCD), plasma, and organic light emitting diode (OLED) are typically used in consumer electronics devices such as computers, gaming consoles, media players, and portable telephones, among others. A flat panel display contains an array of display elements that each receive a signal that represents the digital picture element to be displayed at that location of the respective element. This signal is referred to as a data value or data line signal and is applied to a carrier electrode of a thin film transistor (TFT) that is coupled to and integrated with the display element. Another carrier electrode of the transistor is connected to a display element charge storage circuit, e.g., a liquid crystal capacitor. The TFT and its connected liquid crystal capacitor are referred to here as a “pixel.” A signal at the control electrode of the transistor, referred to as a gate signal, modulates or turns on and off the transistor to apply the data line signal to the charge storage circuit which produces an analog pixel signal across the liquid crystal capacitor that controls the contribution of the particular connected display element to the overall display image.

Thousands or millions of copies of the display element including its associated TFT (e.g., an LCD cell and its associated field effect transistor, or an organic LED) are reproduced in the form of an array, on a transparent substrate such as a plane of glass or plastic. The array is overlaid with a grid of data lines and gate lines. The data lines serve to deliver the data signals to the carrier electrodes of the transistors and the gate lines serve to apply the gate signals to the control electrodes of the transistors. In other words, each of the data lines is coupled to a respective group of display elements, typically referred to as a column of display elements, while each of the gate lines is coupled to a respective row of display elements.

Each data line is coupled to a data line driver circuit that receives digital control and data signals from a signal generator. The latter translates incoming digital pixel values (for example, red, green and blue pixel values) into data signals (with appropriate timing). The data line driver then performs the needed voltage level shifting to produce a data line signal with the needed fan-out (current capability).

The display element, the switch element and the grid of data lines and gate lines are typically formed using microelectronic semiconductor processing techniques directly on the transparent substrate. This conserves space and allows for a direct and immediate connection for each o the millions of pixels. However, microelectronics formed on a glass substrate do not behave the same as those formed on a silicon substrate. The TFTs on the glass substrate have inconsistent performance and degrade quickly over time and with use. As a result, the quality, accuracy, and appearance of the display changes as the transistor behavior changes.

The changes can result in slow and inconsistent response times on the display as the TFT requires higher inputs to obtain the same response or as the TFT develops a capacitance or impedance that slows its reaction time. In particular, the TFT often requires increasing gate driver voltages to be turned on. Unfortunately, if the gate driver voltages are not increased, the pixel may not turn on and may be “dead”.

### SUMMARY

An embodiment of the invention is a display that includes a transparent substrate and a plurality of pixel transistors that are formed on the transparent substrate to generate an image for display in which a gate driver threshold voltage for a gate driver may be determined that accurately turns on the pixel transistor to generate an image.

A transistor drive circuit may be used to drive the pixel transistors to generate the image. The transistor drive circuit may include a gate driver and data line driver. Further, a test circuit may be used to: adjust voltages that are applied by the gate driver to a pixel transistor; and determine the voltage of the gate driver when a current spike has occurred to the pixel transistor which causes the pixel transistor to turn on. Once this threshold voltage for the gate driver to turn on the pixel transistor has been determined, it may be stored in a storage device for future use by the gate driver. Other embodiments are also described and claimed.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 is a combined circuit schematic and block diagram of an example display system or display device, in which embodiments of the invention may be implemented.

FIG. 2 is a combined circuit and block diagram of a test circuit to determine threshold voltages to turn on pixel transistors.

FIG. 3 shows graphs that illustrate the determination of a threshold voltage to turn on a pixel transistor.

FIG. 4 shows a table that may be maintained by a storage device to store threshold voltages.

FIG. 5 is a flow diagram of an example process to determine a threshold voltage to turn on a pixel transistor.

### DETAILED DESCRIPTION

Several embodiments of the invention with reference to the appended drawings are now explained. Whenever the shapes, relative positions and other aspects of the parts described in the embodiments are not clearly defined, the scope of the invention is not limited only to the parts shown, which are meant merely for the purpose of illustration. Also, while numerous details are set forth, it is understood that some embodiments of the invention may be practiced without these details. In other instances, well-known circuits, structures, and techniques have not been shown in detail so as not to obscure the understanding of this description.

As discussed below, the present disclosure relates to a display that includes a transparent substrate and a plurality of pixel transistors that are formed on the transparent substrate to generate an image for display in which a gate driver threshold voltage for a gate driver may be determined that accurately turns on the pixel transistor to generate an image. A transistor drive circuit may be used to drive the pixel transistors to generate the image. The transistor drive circuit may include a gate driver and data line driver. In one embodiment, a test circuit may be used to: adjust voltages that are applied by the gate driver to a pixel transistor; and determine the voltage of the gate driver when a current spike has occurred to the pixel transistor which causes the pixel transistor to turn on. Once this threshold voltage for the gate driver to turn on the pixel transistor has been determined, it may be stored in a storage device for future use by the gate driver.

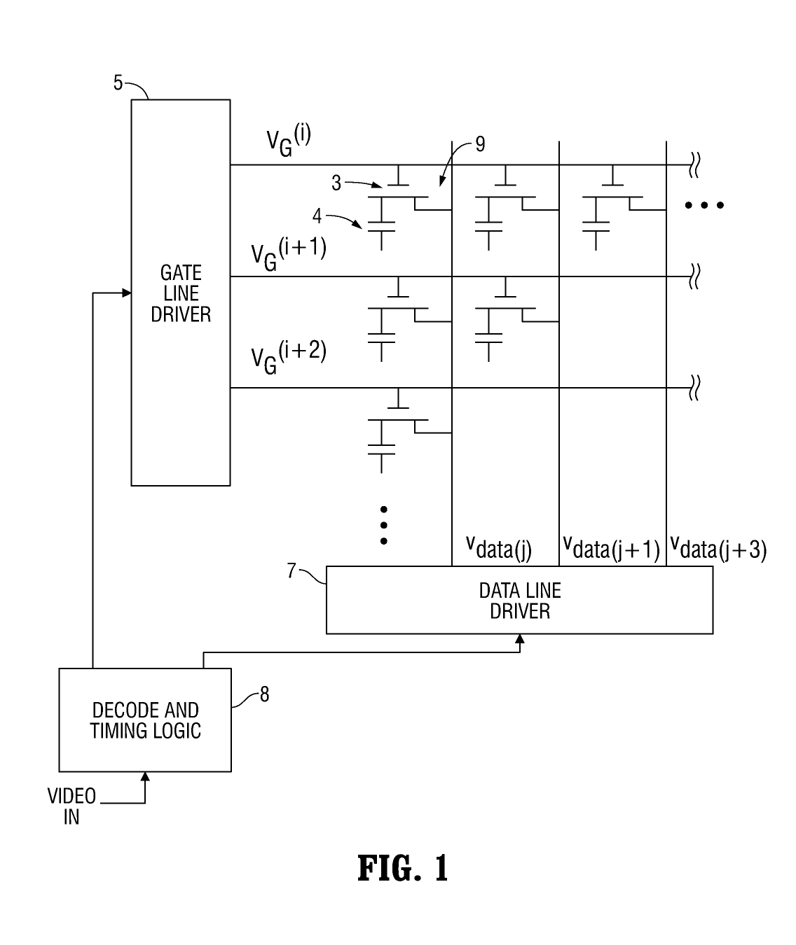

With this in mind, and referring now to FIG. 1, a combined circuit schematic and block diagram of an example display system or display device, in which embodiments of the invention may be implemented, is shown. The system has an array of display elements or pixels that form an image viewable region of a screen, for instance. Each individual pixel may include a transistor 3, e.g., a thin film transistor (TFT), that will be operated partly as a switch, to selectively apply (turn on and turn off) a data line signal that is received on one of its carrier electrodes, on to a plate of a capacitor 4 that is connected to its other carrier electrode. The transistor 3 in combination with the capacitor 4 may be referred to as the pixel or pixel transistor 9.

In this case, each transistor 3 of the respective pixel has its carrier electrode directly connected to a respective gate line that is driven by a voltage source V_{G}, and these voltage sources can be found within gate line driver circuitry 5. Examples of voltage sources V_{G(i) . . .} B_{G(i+2)} and associated gate lines are shown, however, any number of voltage sources and associated gate lines may be present dependent upon the number of pixels. The data line signals are provided by voltage sources V_{data} that are found within data line driver circuitry 7. The data line driver circuitry 7, also called the source driver circuitry, receives control and digital pixel signals from decode and timing logic 8. The latter translates incoming digital video pixel values (for example, red, green and blue digital pixel values) into analog data signals with appropriate timing, that are driven onto the data lines. The data line driver 7 performs the needed voltage level shifting, for example, to produce a data line voltage having not just the needed fan out or current capability, but also the desired amplitude or signal swing with the appropriate gray level voltage. Examples of voltage sources V_{data(j) . . .} V_{G(j+2)} and associated data lines are shown, however, any number of voltage sources and associated data lines may be present dependent upon the number of pixels. Therefore, the display system includes transistor drive circuitry that includes the gate line driver circuitry 5 and the data line driver circuitry 7.

The capacitor 4 may include a liquid crystal capacitor that is formed between a pixel plate electrode and a common plate or electrode, where the latter is, in this example, directly connected to a number of other pixels in the same column, by virtue of a common voltage line that runs vertically as shown (similar to the data lines). A further capacitor (not shown), referred to as a storage capacitor, may be added to the pixel electrode, to increase the analog storage at that node. Other circuit arrangements for a storage circuit at the pixel electrode are possible. It should be appreciated that the pixel transistors 9 and the previously-described circuitry may be formed on a transparent substrate, such as, glass.

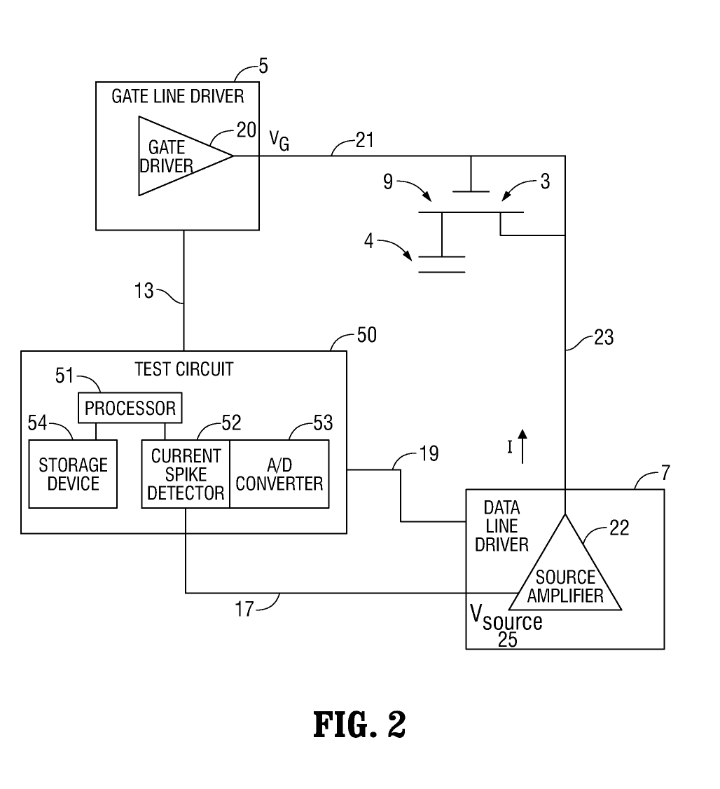

With additional reference to FIG. 2, a test circuit 50 may be coupled to gate line driver 5 and data line driver 7 via lines 13 and 17. In this example, gate line driver 5 includes a gate driver 20 to drive a gate voltage VG via gate line 21 to transistor 3 of pixel transistor 9 and data line driver 7 includes a source amplifier 22 to amplify and output a current (I) via data line 23 to transistor 3 of pixel transistor 9.

Test circuit 50 may include: a processor 51 to control test circuit operations, a current spike detector 52 to detect current spikes, an A/D converter 53, and a data storage device 54 to store relevant values, as will be described.

Test circuit 50 under the control of processor 51 may perform test operations including controlling a gate driver 20 of gate line driver 5 to adjust gate voltages (V_{G}) that are applied by the gate driver 20 to pixel transistor 9. In particular, test circuit 50 may be used to command the gate driver 20 to continually increase voltages (V_{G}) until test circuit 50 determines that the voltage (V_{G}) of the gate driver 20 has caused a current spike to occur at pixel transistor 9, which causes the pixel transistor 9 to turn on. More particularly, capacitor 4 turns on to display the image. At this point, the voltage (V_{G}) applied by gate driver 20 has become the threshold voltage (V_{TH}) to turn on the pixel transistor 9. Once this threshold voltage used by gate driver 20 to turn on pixel transistor 9 has been determined, it may be stored in storage device 54 of the test circuit 50 for future use by the gate driver 20.

In one embodiment, current spike detector 52 of test circuit 50 is coupled to the source amplifier 22 of the data line driver 7 via line 17 to detect the current spike to the pixel transistor 9, which causes pixel transistor 9 to turn on. In particular, when the correct threshold voltage (V_{TH}) is applied by gate driver 20 to pixel transistor 9, the current (I) will be outputted by source amplifier 22 through data line 23 to transistor 3 of pixel transistor 9 such that pixel transistor 9 is turned on. At this point V_{SOURCE} 25 of source amplifier 22 falls to zero, identifying that the current spike has occurred (i.e., the current (I) has been outputted by source amplifier 22), and current spike detector 52 detects that V_{SOURCE} 25 has fallen to 0 via line 17. Based upon this, test circuit 50 determines that the correct threshold voltage (V_{TH}) has been applied by gate driver 20 to cause the current spike to occur, such that pixel transistor 9 has been turned on, and test circuit 50 may command that V_{TH} for that particular pixel transistor 9 and gate driver 20 be stored by storage device 54.

In this way, because the threshold voltage V_{TH} used by gate driver 20 to turn on pixel transistor 9 has been determined, and is now stored in storage device 54 of the test circuit 50, this threshold voltage V_{TH} can now be used (e.g., after testing) by gate driver 20 to ensure that pixel transistor 9 is subsequently turned on. For example, test circuit 50 may command that gate line driver 5 utilize the newly determined threshold voltage V_{TH}. Also, test circuit 50 may additionally command that the voltage V_{SOURCE} 25 of the source amplifier 22, just prior to the current spike, also be stored by storage device 54. This stored V_{SOURCE} value may be used by data line driver 7, as commanded by test circuit 50 via line 19, to increase the voltage of source amplifier 22, in similar fashion to the way that V_{TH} is used for gate driver 20, to ensure that pixel transistor 9 is turned on. Additionally, A/D converter 53 may be used convert the analog values of V_{TH} and V_{SOURCE} to appropriate digital values for storage into storage device 54, as will be described, such that they can be subsequently used by the gate line driver 5 and data line driver 7.

It should be appreciated that, in this example, test circuit 50 has been shown and described as being coupled to a gate driver 20 of gate line driver 5 and a source amplifier 22 of data line driver 7 to determine the threshold voltage (V_{TH}) value required to turn on a single pixel transistor 9, for simplicity's sake, but that test circuit 50 may be coupled to many different gate drivers and source amplifiers of the gate driver and data line driver to determine the appropriate V_{TH} values for any number of pixel transistors. Further, it should be appreciated that by determining and storing updated V_{TH}'s for gate drivers to turn on pixel transistors, that pixel transistors that have become slow, inconsistent, and that require higher input voltages, can be compensated for and still turned on by updated V_{TH} values.

Additionally, it should be appreciated that test circuit 50 under the control of processor 51 may operate as any type of computing device, and that test circuit 50 may operate under the control of programs, firmware, or routines to execute the methods or processes in accordance with the embodiments of the operations, previously described.

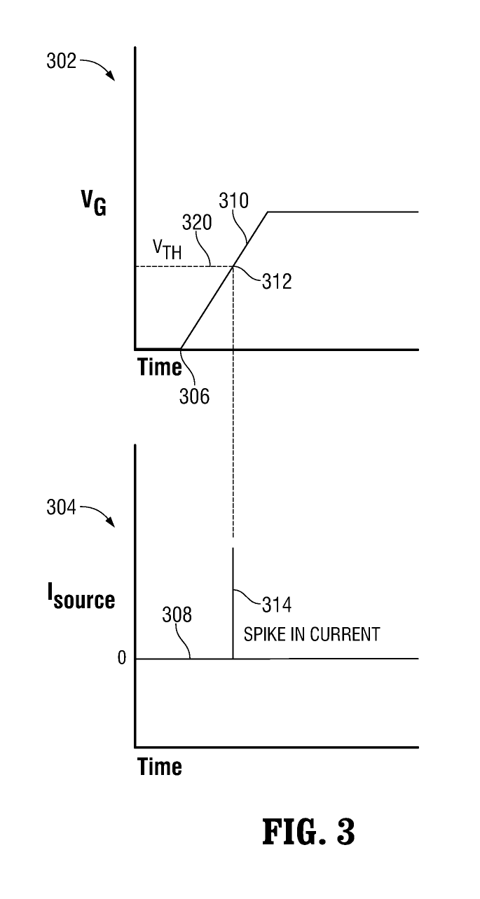

Continuing with the description, with additional reference to FIG. 3, FIG. 3 shows graphs 302 and 304 that illustrate the determination of the threshold voltage (V_{TH}) to turn on the pixel transistor 9. As can be seen in graph 302, in which the y-axis denotes gate voltage (VG) and the x-axis denotes time, test circuit 50 may be used to control gate driver 20 of gate line driver 5 to incrementally increase gate voltages (V_{G}) (as shown by angled upwards line 310) that are applied by the gate driver 20 to the pixel transistor 9. At point 312 of angled upwards line 310, the threshold voltage (V_{TH}) 312 has been reached and pixel transistor 9 has been turned on.

As can be seen in graph 304, in which the y-axis denotes current from the source amplifier 22 (I_{source}) and the x-axis denotes time, line 308 shows that current remains at zero until the current spike at 314 occurs, in which the current flows out of the source amplifier 22 to the pixel transistor 9 to turn on the pixel transistor. At this point, the gate voltage (V_{G}) 310 applied by gate driver 20, under the control of test circuit 50, has become the threshold voltage (V_{TH}) 320 (as shown in graph 302) to turn on the pixel transistor 9, as indicated by the spike in current 314 (as shown in graph 304), which is released by source amplifier 22 to turn on pixel transistor 9.

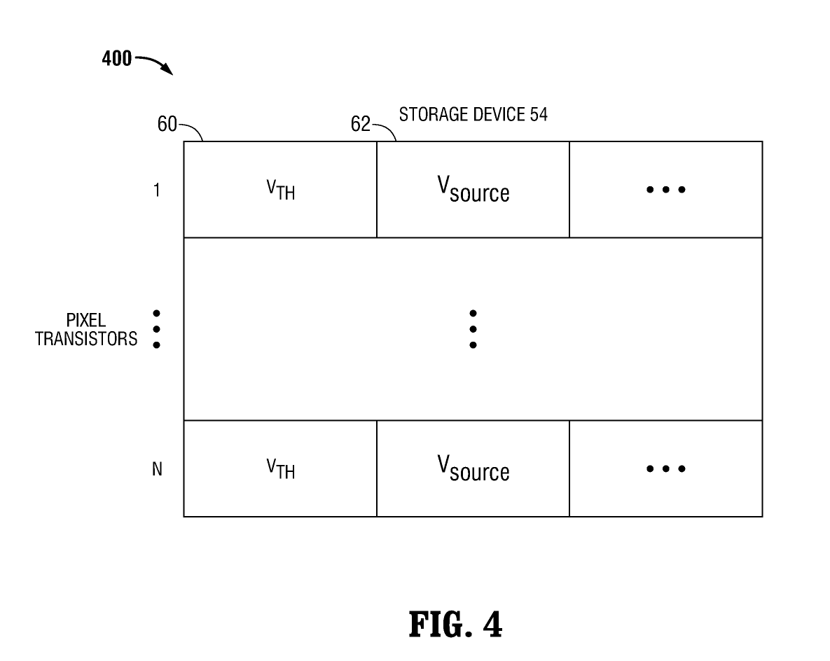

As previously described, once this threshold voltage (V_{TH}) 320 used by gate driver 20 to turn on pixel transistor 9 has been determined, it may be stored in storage device 54 of the test circuit 50 for future use by the gate driver 20. With additional brief reference to FIG. 4, FIG. 4 shows a table 400 that may be maintained by storage device 54. For each pixel transistor 1-N, table 400 may store a threshold voltage V_{TH} 60 that has been previously tested and determined by test circuit 50 to turn on the pixel transistor by the associated gate driver 20. Also, for each pixel transistor 1-N, table 400 may store a V_{SOURCE} value 62 (the voltage just prior current spike) associated with the source amplifier 22. Table 400 of storage device 54 may additionally store other values. Further, it should be appreciated that the V_{TH} values 60 and V_{SOURCE} values 62 may be digital values based upon conversion by A/D converter 53 and modification by test circuit 50.

In particular, as has been described, because a stored threshold voltage V_{TH} 60 used by a gate driver to turn on a pixel transistor has been determined by test circuit 50, and is now stored in storage device 54 of test circuit 50 after or during testing, test circuit 50 can command the update of the gate line driver 5 and gate driver 20 to utilize the newly determined and stored threshold voltage V_{TH} to ensure that the pixel transistor is turned on and to compensate for the degradation of the pixel transistor. Likewise, after or during testing, test circuit 50 may command the update of the data line driver 7 and source amplifier 22 to utilize the newly determined and stored V_{SOURCE} value 62.

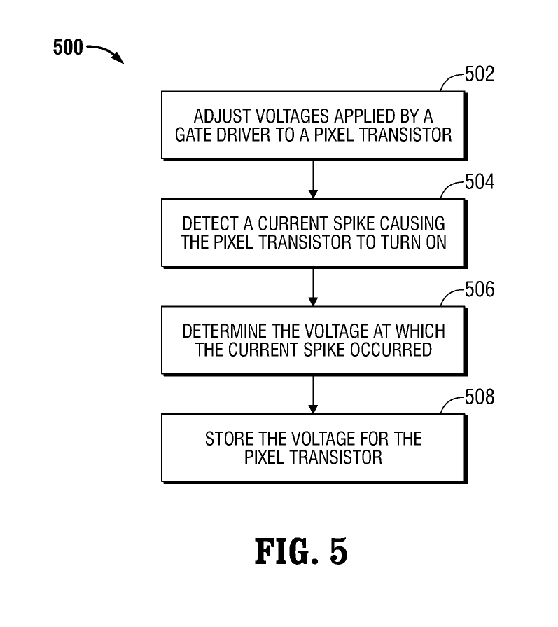

With additional reference to FIG. 5, a flow diagram of an example process 500 to determine a gate driver threshold voltage (V_{TH}) for a gate driver that turns on a pixel transistor to generate an image is shown. The method may begin by adjusting voltages applied by a gate driver to a pixel transistor (block 502). Next, a current spike may be detected that causes the pixel transistor to turn on (block 504). The voltage at which the current spike occurred is determined (block 506), which is the gate driver threshold voltage (V_{TH}) for a gate driver that turns on the pixel transistor. The gate driver threshold voltage (V_{TH}) for the pixel transistor is then stored (block 508).

As previously described, test circuit 50, under the control of processor 51, performs test operations to control a gate driver 20 of gate line driver 5 to adjust gate voltages (V_{G}) that are applied by the gate driver 20 to pixel transistor 9. In particular, test circuit 50 may be used to command the gate driver 20 to continually increase voltages (V_{G}) until test circuit 50 determines that the voltage (V_{G}) of the gate driver 20 is a threshold voltage (V_{TH}) that has caused a current spike to occur at pixel transistor 9 and to turn on pixel transistor 9. The threshold voltage (V_{TH}) may be stored in storage device 54 of the test circuit 50 for future use by the gate driver 20. The test circuit 50 detects the current spike to the pixel transistor 9 that turns on pixel transistor 9 by determining that the current (I) is outputted by the source amplifier 22 of the data line driver 7 by the current spike detector 52 detecting V_{SOURCE} 25 of source amplifier 22 falling to zero (i.e., indicating the current (I) has been outputted by source amplifier 22).

In this way, because the threshold voltage V_{TH} used by gate driver 20 to turn on pixel transistor 9 has been determined by test circuit 50, and is now stored in storage device 54 of the test circuit 50, this threshold voltage V_{TH} can now be used by gate driver 20 to ensure that pixel transistor 9 is subsequently turned on. In particular, because a threshold voltage V_{TH} used by a gate driver to turn on a pixel transistor has been determined by test circuit 50 and is stored in the storage device 54 of test circuit 50, test circuit 50 can command the update of the gate line driver 5 and gate driver 20 to utilize the newly determined and stored threshold voltage V_{TH} to ensure that the pixel transistor 9 is turned on and can compensate for the degradation of the pixel transistor.

Test circuit 50, under the control of processor 51, may implement the previously-described test process to determine threshold voltages to turn on pixel transistors for the display at many different times. For example, the test circuit 50 may implement the test process: when the display is turned on; when the display is turned off; after the display has not been used for a predetermined period of time; after the device has be turned on; after the device has be turned off; upon lock screen; after lock screen; etc. It should be appreciated that any suitable timing methodology may be utilized to implement the test process.

It should be appreciated that test circuit 50 under the control of processor 51 may operate as any type of computing device, and that test circuit 50 may operate under the control of programs, firmware, or routines to execute the methods or processes in accordance with the embodiments of the operations, previously described. For purposes of the present specification, it should be appreciated that the terms “computing device,” “processor,” “circuit” etc., refer to any machine or collection of logic that is capable of executing a sequence of instructions and shall be taken to include, but not limited to, general purpose microprocessors, special purpose microprocessors, central processing units (CPUs), digital signal processors (DSPs), application specific integrated circuits (ASICs), multi-media controllers, signal processors, microcontrollers, etc.

Components of the various embodiments of the invention may be implemented as hardware, software, firmware, microcode, or any combination thereof. When implemented in software, firmware, or microcode, the elements of the embodiment of the invention are the program code or code segments that include instructions to perform the necessary tasks. A code segment may represent a procedure, a function, a sub-program, a program, a routine, a sub-routine, a module, a software package, or any combination of instructions, data structures, or program statements.

The program, instruction, or code segments may be stored in a processor readable medium. The “processor readable or accessible medium” may include any medium that can store, transmit, or transfer information. Examples of accessible media or storage devices include an electronic circuit, a semiconductor memory device, a read only memory (ROM), a flash memory, an erasable ROM (EROM), a floppy diskette, a compact disk (CD-ROM), an optical disk, a hard disk, a fiber optic medium, a radio frequency (RF) link, etc. The processor readable or accessible medium may include data that, when accessed by a processor or circuitry, cause the processor or circuitry to perform the operations described herein. The term “data” herein refers to any type of information that is encoded for machine-readable purposes. Therefore, it may include programs, code, data, files, etc.

While certain embodiments have been described and shown in the accompanying drawings, it is to be understood that such embodiments are merely illustrative of and not restrictive on the broad invention, and that the invention is not limited to the specific constructions and arrangements shown and described, since various other modifications may occur to those of ordinary skill in the art. The description is thus to be regarded as illustrative instead of limiting.

What is claimed is:

1. A display comprising:
a transparent substrate;
a plurality of pixel transistors formed on the transparent substrate to generate an image for display;
a transistor drive circuit to drive the pixel transistors to generate the image; and
a test circuit to:
adjust voltages applied by a gate driver of the transistor drive circuit to a pixel transistor;
determine the voltage when a current spike has occurred to the pixel transistor causing the pixel transistor to turn on; and
store the voltage for the pixel transistor.

2. The display of claim 1, wherein the pixel transistor is a pixel thin film transistor (TFT).

3. The display of claim 1, wherein the transparent substrate is a glass substrate.

4. The display of claim 1, wherein the transistor drive circuit further comprises a data line driver.

5. The display of claim 1, wherein the stored voltage is used by the gate driver.

6. The display of claim 1, further comprising a current spike detector coupled to a source amplifier of a data line driver to detect the current spike to the pixel transistor.

7. The display of claim 6, wherein the test circuit stores the voltage of the source amplifier prior to the current spike.

8. The display of claim 1, wherein the test circuit operates when the display is turned on or off or when the display has not been used for a predetermined period of time.

9. A method for detecting a voltage to turn on a pixel transistor comprising:
adjusting voltages applied by a gate driver to a pixel transistor formed on a transparent substrate;
determining the voltage when a current spike has occurred to the pixel transistor causing the pixel transistor to turn on; and
storing the voltage for the pixel transistor.

10. The method of claim 9, wherein the pixel transistor is a pixel thin film transistor (TFT).

11. The method of claim 9, wherein the transparent substrate is a glass substrate.

12. The method of claim 9, wherein the stored voltage is used by the gate driver.

13. The method of claim 9, further comprising detecting the current spike to the pixel transistor from a source amplifier of a data line driver.

14. The method of claim 13, further comprising storing the voltage of the source amplifier prior to the current spike.

15. A display system comprising:
mean for adjusting voltages applied by a gate driver to a pixel transistor formed on a transparent substrate;
means for determining the voltage when a current spike has occurred to the pixel transistor causing the pixel transistor to turn on; and
means for storing the voltage for the pixel transistor.

16. The display system of claim 15, wherein the pixel transistor is a pixel thin film transistor (TFT).

17. The display system of claim 15, wherein the transparent substrate is a glass substrate.

18. The display system of claim 15, wherein the stored voltage is used by the gate driver.

19. The display system of claim 15, further comprising means for detecting the current spike to the pixel transistor from a source amplifier of a data line driver.

20. The display system of claim 19, further comprising means for storing the voltage of the source amplifier prior to the current spike.
